(19) United States
(12) Patent Application Publication
(10) Pub. No.: US 2025/0292187 A1
(43) Pub. Date: Sep. 18, 2025

(54) UTILIZATION-BASED METERING FOR RESOURCE AS-A-SERVICE

(71) Applicant: Lenovo Global Technology (United States) Inc., Morrisville, NC (US)

(72) Inventor: Mark Azadpour, Grapevine, TX (US)

(21) Appl. No.: 18/604,856

(22) Filed: Mar. 14, 2024

(51) Int. Cl. G06Q 10/067; G06Q 30/0283

(52) U.S. Cl. CPC G06Q 10/067; G06Q 30/0284

(57) ABSTRACT

One embodiment provides a method, the method including: receiving, at a utilization-based metering system, a request from a user to use a processing resource of an entity offered as-a-service by the entity; setting, using the utilization-based metering system, an initial rate for usage of the processing resource over a period of time; validating, using the utilization-based metering system and in view of the period of time, the initial rate, wherein the validating includes identifying an amount of usage of the processing resource for the period of time and determining whether the initial rate meets a predetermined criteria in view of the amount of usage; and setting, using the utilization-based metering system and based upon the validating, a subsequent rate for usage of the processing resource for a subsequent period of time. Other aspects are claimed and described.

### BACKGROUND

Since computer processing has become more complex and requires the use of higher performance computing capabilities, some companies have offered the use of processing resources as-a-service. This allows a client to make use of the high performance computing capabilities without having to not only purchase the expensive equipment or components, but also having to maintain the equipment or components. Instead a company or other entity owns and maintains the equipment and components and the client can essentially rent it to perform the necessary processing job. This gives the client the flexibility to use high performance computing resources without having to purchase or maintain the high-performance computing resources, particularly when these resources are not needed all of the time. This business model turns a capital expenditure to a consumption-based business offering. Furthermore, the provider owns the equipment and, after the terms of the contract, the provider is in charge of recovering the equipment and the recycle/resale of the equipment. This provides an environmentally friendly business model.

### BRIEF SUMMARY

In summary, one aspect provides a method, the method including: receiving, at a utilization-based metering system, a request from a user to use a processing resource of an entity offered as-a-service by the entity; setting, using the utilization-based metering system, an initial rate for usage of the processing resource over a period of time; validating, using the utilization-based metering system and in view of the period of time, the initial rate, wherein the validating includes identifying an amount of usage of the processing resource for the period of time and determining whether the initial rate meets a predetermined criteria in view of the amount of usage; and setting, using the utilization-based metering system and based upon the validating, a subsequent rate for usage of the processing resource for a subsequent period of time. The initial rate may be set utilizing historical data, an artificial intelligence empowered model that calculates the initial rate, and/or other techniques. The subsequent rate may also be affected by secondary factors that may be drawn from artificial intelligence monitoring of the system and may include, but are not limited to, cost of maintenance, frequency of service calls, adaptive market driven rate calculations, and/or the like.

Another aspect provides a system, the system including: a processor; a memory device that stores instructions that, when executed by the processor, causes the system to: receive, at a utilization-based metering system, a request from a user to use a processing resource of an entity offered as-a-service by the entity; set, using the utilization-based metering system, an initial rate for usage of the processing resource over a period of time; validate, using the utilization-based metering system and in view of the period of time, the initial rate, wherein the validating includes identifying an amount of usage of the processing resource for the period of time and determining whether the initial rate meets a predetermined criteria in view of the amount of usage; and set, using the utilization-based metering system and based upon the validating, a subsequent rate for usage of the processing resource for a subsequent period of time.

A further aspect provides a product, the product including: a computer-readable storage device that stores executable code that, when executed by a processor, causes the product to: receive, at a utilization-based metering system, a request from a user to use a processing resource of an entity offered as-a-service by the entity; set, using the utilization-based metering system, an initial rate for usage of the processing resource over a period of time; validate, using the utilization-based metering system and in view of the period of time, the initial rate, wherein the validating includes identifying an amount of usage of the processing resource for the period of time and determining whether the initial rate meets a predetermined criteria in view of the amount of usage; and set, using the utilization-based metering system and based upon the validating, a subsequent rate for usage of the processing resource for a subsequent period of time.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for providing a utilization-based metering system that sets, validates, and resets rates based upon usage by a user of a processing resource of an entity offered as-a-service by the entity.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

High-performance computing (HPC) resources may include memory, graphics processing unit (GPU), central processing unit (CPU) or processing core, and/or the like. In order to provide high-performance computing resources as-a-service, the entity providing the service charges the client a rate. The rate is intended to cover the costs associated with having and maintaining the components. Generally, the entity offers a subscription service that allows the client to buy use of the resources for a specified period of time, for example, six months, a year, two years, and/or the like. The entity will then provide the appropriate resource to the client for that specified period of time.

Traditionally, the subscription pricing model has worked utilizing a flat rate. The client pays a certain amount each month or payment period regardless of the usage of the resource. In order to make such a pricing model work for both the client and the hosting entity (i.e., the entity who is providing the resources as-a-service), the client has to provide an accurate projection regarding a number and/or amount of time a resource or resources will be utilized. If the projection is higher than what is actually utilized, the client ends up paying more for each resource on a unit usage cost. If the projection is lower than what is actually needed, the hosting entity may cut off use of the resource before the job is completed, may be underpaid, or may charge additional costs for the inaccurate projection. Thus, there is incentive for the client to make an accurate projection, but it is not always possible to be completely accurate. The described system and method provides a technique to utilize an artificial intelligence (AI) based algorithm that can be used to set an initial rate which will be subject to change on a regular basis, thereby reducing the need for the client to make accurate projections as found in the traditional techniques. The AI model can be trained on datasets from previous requests and job and clients to make predictions regarding an initial rate.

Some hosting entities may attempt to identify a usage of a resource by identifying a resource utilization at various times. The hosting entity then averages the resources to make a guess regarding the consumption of a resource over a period of time and then bill the client based upon this guessed consumption. The problem with this is that since the snapshots are taken at discrete periods of time, the resource utilization can be significantly more or significantly less than what is actually used over the period of time. In other words, since resource utilization may fluctuate during a period of time, taking snapshots and averaging the resource utilization is not the most accurate technique for identifying an actual resource utilization over the period of time. Thus, the client could be overbilled for consumption of a resource that did not actually occur.

Accordingly, the described system and method provides a technique for providing a utilization-based metering system that sets, validates, and resets rates based upon usage by a user of a processing resource of an entity offered as-a-service by the entity. The utilization-based metering system receives a request from a user, also referred to as a client, to use a processing resource of an entity offered as-a-service by the entity, also referred to as a hosting entity. The request may include information related to what resource is to be used, how long the resource is to be used, the job for which the resource will be used, an estimation of the usage of the resource, the client providing the request, a subgroup providing the request, and/or the like. It should be noted that while a single resource is referred to herein, requests will generally include more than one resource to be used for one or more jobs. Thus, the term resource is not intended to limit the scope of this disclosure to a single resource.

Based upon the request, an initial rate for usage of the resource over a period of time is set by the utilization-based metering system. The initial rate can be set using one or more techniques, and the technique(s) selected may be based upon any additional information the hosting entity may have regarding the client, job, and/or the like. For example, if the client or subgroup is one that has utilized resources of the hosting entity before, the system may utilize historical information regarding historical resource usage to set the initial rate. As another example, the system may utilize an industry standard initial rate. The initial rate may be set based on historical data and using an artificial intelligence empowered model that calculates the initial rate. As described more herein, other techniques for setting the initial rate are contemplated and possible. The initial rate is set for a period of time that allows for monitoring of the resource usage, for example, 30 days, 60 days, 3 months, a fraction of an overall subscription time, and/or the like. Once the period of time has expired is almost expired (e.g., a week before, a few days before, etc.), the system validates the initial rate.

To validate the initial rate, the system monitors the usage of the processing resource over the period of time. Thus, the system identifies an amount of usage of the processing resource for the period of time and determining whether the initial rate meets a predetermined criteria in view of the amount of usage. The predetermined criteria may be an overhead cost, a minimum charge amount, a minimum usage amount, and/or the like. Based upon the validating, the system sets a subsequent rate for usage of the processing resource for a subsequent period of time. In other words, the system determines if the initial rate meets the predetermined criteria and makes adjustments, if needed, to the rate for subsequent periods of time. If the initial rate meets the predetermined criteria, the subsequent rate may be the same as the initial rate. If the initial rate does not meet the predetermined criteria, the subsequent may be adjusted to be different than the initial rate and may be calculated so that the predetermined criteria will be met in the subsequent time period. Setting of the subsequent rate may also be affected by other secondary factors drawn from artificial intelligence monitoring of the system which include, but is not limited to, cost of maintenance, frequency of service calls, adaptive market driven rate calculations, and/or the like.

Therefore, a system provides a technical improvement over traditional methods for setting a rate for usage of a HPC resource. The described system and method are able to accurately identify resource consumption over a period of time and bill a client for the resources actually used, instead of guessing how much the client has used over a period of time. Instead of relying on averaging snapshots that may provide an inaccurate accounting of resource utilization, the described system and method monitors the usage of a resource or resources and then calculates a rate for usage of the processing resource based upon the monitored usage. Thus, instead of an inaccurate technique for calculating resource utilization and then billing based upon this estimated resource usage, the described system provides a more accurate technique for monitoring usage and billing based upon the usage, thereby resulting in more accurate billing that changes as the actual resource usage changes.

The illustrated example embodiments will be best understood by reference to the figures. The following description is intended only by way of example, and simply illustrates certain example embodiments.

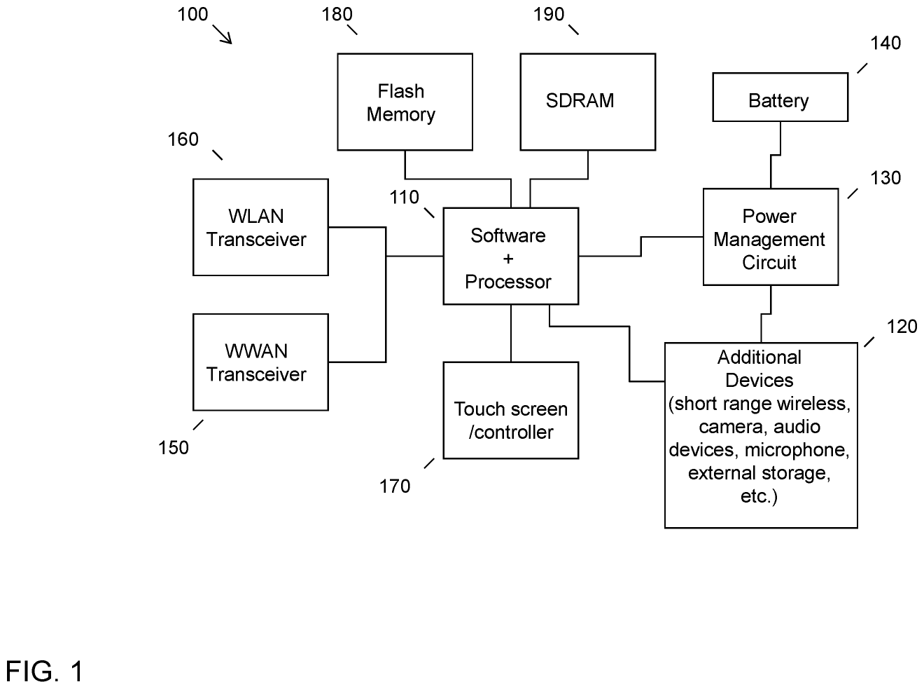

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

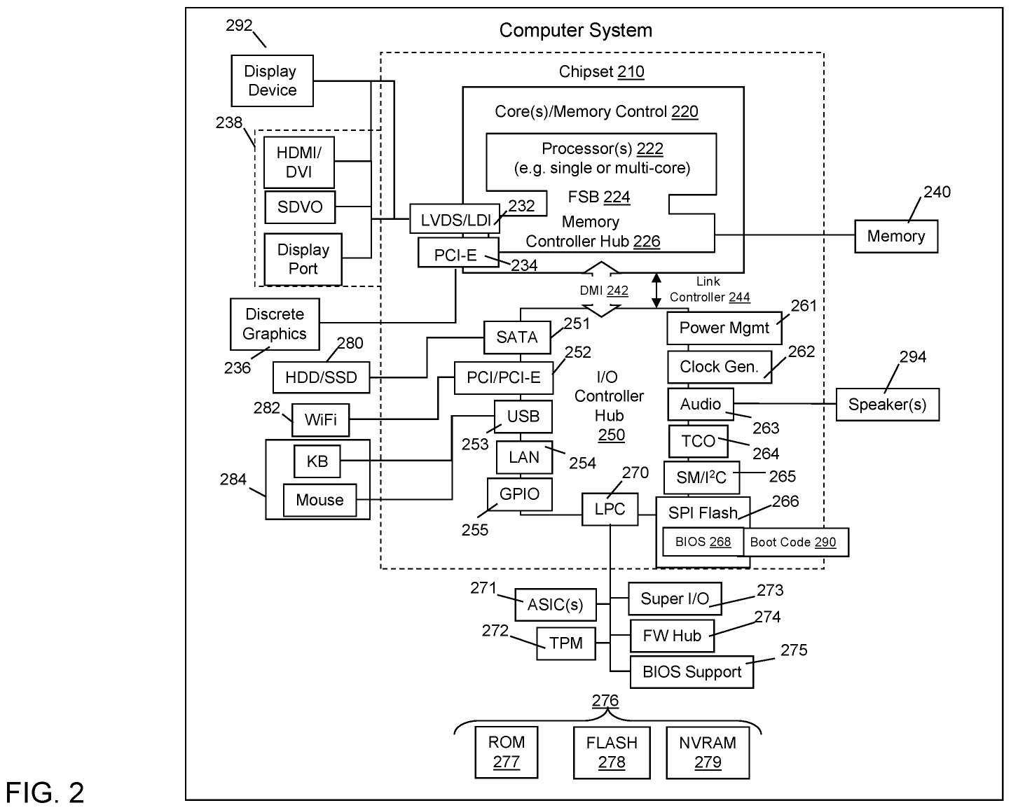

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used within the utilization-based metering system to calculate initial and/or subsequent rates, monitor resource usage, and/or provide the processing resource. For example, the circuitry outlined in FIG. 1 may be implemented in a tablet or smart phone embodiment, whereas the circuitry outlined in FIG. 2 may be implemented in a personal computer embodiment.

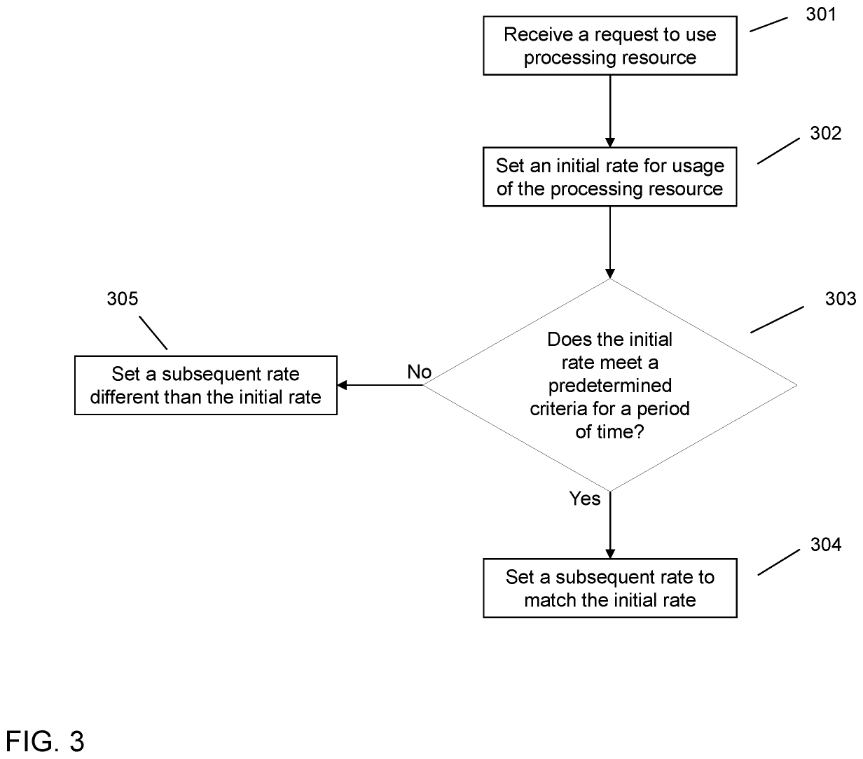

FIG. 3 illustrates an example method for providing a utilization-based metering system that sets, validates, and resets rates based upon usage by a user of a processing resource of an entity offered as-a-service by the entity. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to provide a utilization-based metering rate for use of a processing resource within the computing node. Additionally, the utilization-based metering system includes modules and features that are unique to the described system.

The utilization-based metering system may be activated to provide information regarding a request so that an initial rate may be computed and set for the request. The utilization-based metering system may also be activated to validate an initial rate and set a subsequent rate. Additionally, the utilization-based metering system may be responsible for monitoring the resource usage. Thus, the system may be activated when the resource utilization needs to be monitored. On the other hand, a separate system may be utilized to perform the monitoring and the monitoring information may be provided to the utilization-based metering system, either in real-time or at predetermined frequencies. In providing the monitoring information, the separate system may provide the raw monitoring information or may provide an aggregation or summary of the monitoring information. Accordingly, the utilization-based metering system may be in communication with the monitoring system if it is different than the utilization-based metering system.

The activation of the utilization-based metering system may be manual, where a user provides an input indicating that the utilization-based metering system should be activated, or automatic where the utilization-based metering system detects a trigger event indicating that the system should be activated. Example trigger events include detection of a request for use of a processing resource, receipt of monitoring information, expiration of a time period indicating a subsequent rate needs to be set, activation of software or an application utilizing the utilization-based metering system (e.g., request receipt and rate set-up application, rate validation application, monitoring information application, etc.), activation of a device that is utilized for setting up, validating, monitoring, and/or resetting rates of usage, and/or the like.

The utilization-based metering system may be a standalone system, may be accessible through other computing devices, and/or a combination thereof. For example, the utilization-based metering system may be a standalone system that can be accessed by a user and/or may be or provide an application that is accessible by a user on another computing device. The utilization-based metering system may be accessible using any type of computing device, for example, personal computer, laptop computer, smartphone, tablet, smartwatch, head-mounted display, smart television or other smart appliance, augmented reality device, virtual reality device, and/or the like. Thus, the utilization-based metering system may be accessible locally using a computing device where the utilization-based metering system is installed and/or may be accessible remotely through another computing device. For example, the utilization-based metering system may be accessed by a user using a device that communicates with the utilization-based metering system to access and/or display requests for processing resources, set rates for usage of the processing resource, validate the rates, and/or monitor the resource usage. However, the utilization-based metering system may be located and operate on a different information handling device to perform the described steps.

The utilization-based metering system may have an associated graphical user interface. The graphical user interface may be provided on a display or monitor, which may or may not be associated with the utilization-based metering system. In other words, the utilization-based metering system may have a dedicated display or monitor or may be accessible using any display or monitor. In either case, the utilization-based metering system may provide instructions to generate and display the graphical user interface on the display device being used to access the utilization-based metering system. The graphical user interface may also be updated and managed based upon instructions provided by the utilization-based metering system. In other words, the utilization-based metering system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the utilization-based metering system. For example, the utilization-based metering system may utilize a client profile, job profile, historical information, and/or the like, to identify an initial rate and/or set a subsequent rate. The graphical user interface may allow for creation of or access to these profiles or historical information by allowing a user to input information regarding the request, processing resources, historical request information, client information, job information, and/or the like. As will be discussed in more detail, the use of user provided information is not the only way that the profile and/or historical information can be created. The utilization-based metering system can then utilize these inputs to create the profile(s), store the historical information, and/or set rates for usage. A user could also use the graphical user interface to adjust information within the profile(s), historical information, rate usage information, and/or the like. Additionally, or alternatively, the user can input a location of information related to one or more of the profiles, historical information, request information, rate usage information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display information of the request, profiles, usage rates, monitoring information, and/or the like. It should be noted that the information to be used by the utilization-based metering system and information provided by the utilization-based metering system can be different for different applications, different computing systems, different users, and/or the like. Thus, the information corresponding to input or output of the utilization-based metering system are not always the same. However, the utilization-based metering system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The utilization-based metering system may utilize one or more artificial intelligence models in analyzing requests, setting rates, performing usage monitoring or analyzing usage monitoring, or any other steps within the described system. Artificial intelligence models may also be used for steps within a step. For example, a model could be utilized to generate or analyze a user or client profile when setting an initial rate or setting a subsequent rate, identify secondary factors when setting a subsequent rate, performing an analysis of the monitoring information when validating the initial rate, and/or the like. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the utilization-based metering system or may be a model that is created from scratch. Since the utilization-based metering system is used in conjunction with receiving requests from users, setting initial rates, validating the initial rates, and setting subsequent rates, some models that may be utilized by the system are analysis models, similarity identification models, large language models, filtering models, classification models, and/or the like. The model may be trained using one or more training datasets. Additionally, as the model is deployed, it may receive feedback to become more accurate over time. The feedback may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model ingests this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The utilization-based metering system may include different components for carrying out different functions of the system, including different steps to be performed. These components may be hardware components or software components. Input devices may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the utilization-based metering system. For example, the utilization-based metering system may include speakers, displays or monitors, haptic output devices, audio output devices, and/or the like.

One software component is a resource monitoring component or application. The resource monitoring component can monitor usage of a resource. The monitoring component may monitor usage of multiple resources at the same time and may also monitor usage of resources by different clients at the same time. In other words, the monitoring component is able to identify that a resource is being utilized, how much of the resource is being utilized, a length of time of the usage of the resource, and also what client or client subgroup is utilizing the resource. The monitoring system can keep the information for each client or client subgroup separate, for example, by storing the information pertaining to a client or client subgroup within a data storage location, by providing the information to the utilization-based metering system for use or storage, and/or the like.

The monitoring component may be in communication with the utilization-based metering system and provide the raw monitoring information to the system, may provide aggregated information, may provide a summary of the monitoring information, and/or the like. As an example of providing aggregated information, the monitoring component may collect the monitoring information for a particular client, client subgroup, job, request, and/or the like, for a particular time period (e.g., a few hours, a day, a few days, a week, etc.) and at the end of the time period may then provide the monitoring information for the entire time period to the utilization-based metering system.

As an example of providing summary information, the monitoring component may collect the monitoring information for a particular client, client subgroup, job, request, and/or the like, for a particular time period (e.g., a few hours, a day, a few days, a week, etc.) and at the end of the time period, instead of providing the raw monitoring information as with the aggregated information, analyze the monitoring information and identify an overall usage to provide a summary of the resource usage over the time period. For example, the monitoring component may identify that over a particular time period a particular resource was used for a particular amount of time. This is in contrast to the aggregated information which would identify the particular times within the time period the resource was utilized, how long the resource was utilized at that time, the user or device that provided instructions for use of the resource, and/or the like.

It should be noted that the monitoring component and utilization-based metering system may work together to analyze the monitoring information and identify how it will be stored, analyzed, utilized (e.g., as raw data, as aggregate data, as summary data, etc.), and/or the like. Additionally, the client, client subgroup, job, request, and/or the like, may provide an indication of how the monitoring information should be stored, for how long the monitoring information should be stored, how the information should be utilized, and/or the like. For example, the client may request detailed information regarding resource usage for its own use. Thus, the monitoring information will need to be stored and utilized in a manner that allows for the provision of the detailed information to the client.

The client subgroup may be a particular client job. Thus, a particular client may have different jobs that are classified as a client subgroup. Alternatively, a client subgroup may be a particular department within a client organization. This client subgroup may also have multiple jobs that are being processed by the hosting entity at the same time. It should be noted that “at the same time” refers to jobs having a time period of overlap with the hosting entity. Thus, one job may start before another job or one job may end after another job, but these are still considered occurring at the same time. Since the hosting entity has many processing resources, the ability to perform multiple jobs at the same time from the same client or across different clients is possible and typical.

The hosting entity provides the use of processing resources as-a-service. Thus, the hosting entity includes many different hardware and software components that are accessible or viewable by the utilization-based metering system. These hardware and software components are in communication to provide the processing resources that may be requested for use by a client. Specifically, the hosting entity provides high-performance computing components that can be dedicated, or portions of which can be dedicated, to perform specific jobs for a client. The hosting entity generally has racks of high-performance computing components that can be utilized for processing job requests of a client. Thus, the number of components and processing resources of the hosting entity is significant and can number in the hundreds, thousands, or even more. Some example processing resources that are commonly processing resources that are offered as-a-service are graphics processing units (GPUs) or graphics processing cores, central processing units (CPUs) or processing cores, memory, and/or the like.

Many of the components and processing resources cannot run alone and require other components, for example, cooling systems, power distribution units, and/or the like. Additionally, a hosting entity frequently has employees who are dedicated to managing and maintaining the processing components. Thus, the hosting entity has not only the cost of the components and processing resources to recover, but also has associated residual costs that reflect the cost of power and other components used for the processing components and resources to function and costs associated with manpower to ensure that the processing components and resources remain functional and any downtime is addressed quickly. Accordingly, all of these costs may be factored into the initial rate or subsequent rate for usage.

At 301, the utilization-based metering system receives a request from a user to use a processing resource of an entity that is offered as-a-service by the entity. In other words, the hosting entity receives a request by a client to utilize the processing resources of the hosting entity. The request may then be input to the utilization-based metering system. The request may be received by a current client or one who has utilized the as-a-service resources before. Alternatively, the request may be received by a completely new client. Clients may also have subgroups or departments that may each provide requests to the hosting entity. Additionally, subgroups or departments may have multiple jobs or requests for processing resources that may run concurrently or at least have overlap between requests. The requests may also include multiple jobs that will be performed within a predetermined length of time of the request. The request typically includes an identification of an overall length of time of usage that the processing resource is going to be needed, for example, 6 months, 12 months, 18 months, 36 months, and/or the like. This length of time will serve as the length of the subscription to the processing resource. Thus, within the length of the subscription, the client may have a single job or may have multiple jobs.

It should be noted that the type of processing resource or resources may not be specifically identified within the request. Rather, the request may identify the job that is to be run using the processing resources and details of the job. From the job identification and/or details of the job, the system can determine what processing resources will need to be utilized to perform the job, particularly in view of the subscription length. Thus, the client may specifically identify which processing resources will be needed for the subscription length or may provide information that allows the system to determine what processing resources will need to be used to perform the job. The request may also identify the job and/or job details, even if this information is not used to determine which processing resources will be utilized.

The request may also identify a resource usage estimation which may identify the amount that a processing resource will be utilized. It should be noted that different processing resources may have different measurement units that identify a usage of the resource. For example, usage of a GPU may be provided in minutes or hours, while usage of a computing core may be provided in a number of cores or units. Thus, the amount may identify a number, a length of time, a percentage, and/or whatever measurement unit that is applicable to the particular processing resource.

Once the request has been accepted and the job is defined, the utilization-based metering system may identify those processing resources that are available to be assigned or dedicated to a particular job. The system may also assign processing resources to perform the job. Some resources may be assigned to multiple jobs. For example, if a job does not need to utilize all of the possible computing power of a resource, the resource could be assigned to more than one job. As an example, a computing core can perform complex simultaneous processing. Thus, if a job is assigned to a core that does not utilize the entire core, other jobs can also be assigned to the same core.

At 302, the utilization-based metering system sets an initial rate for usage of the processing resources over a period of time. In other words, the system determines a rate that will be charged for use of the processing resources over a period of time. The period of time that is chosen is shorter than the subscription length and may be a relatively short period of time as compared to the subscription length. Over this period of time, the system will monitor the resource usage which will then be used to validate the initial rate that was set. Accordingly, the period of time may be long enough to ensure a monitoring period that provides a good view of the resource usage, but is also short enough that an incorrect initial rate will not be particularly detrimental to either the client or hosting entity. Thus, some example periods of time may be 30 days, 45 days, 60 days, 90 days, 6 weeks, and/or the like. The length of the period of time may vary based upon the request, the job, the client providing the request, and/or the like. This period of time will be referred to as a monitoring period for ease of readability.

In order to set the initial rate, the utilization-based metering system identifies an estimated resource usage over the monitoring period. The resource usage estimation may be provided by the client or may be computed by the utilization-based metering system based upon the job, job details, resource request, and/or the like. The estimated resource usage may be for the entire subscription length or may be for the monitoring period. In the case that the estimated resource usage is provided for the entire subscription length, the system may perform the calculation to determine what the average resource usage would be for the monitoring period. Additionally, or alternatively, the system may be able to predict highs and lows in the resource usage over the subscription length, for example, using historical information, using one or more artificial intelligence models, and/or the like. Using these predicted highs and lows, the system may be able to more accurately estimate a resource usage for the monitoring period from the resource usage provided by the client. The system may also perform a study to determine a resource usage by the client. The study may include monitoring the client's usage of resources for similar jobs, analyzing a usage of resources for historically similar jobs, and/or the like.

Additionally, or alternatively, in computing the resource usage estimation the system may utilize historical information regarding similar requests or jobs, historical information regarding requests or jobs received from the same client, one or more artificial intelligence models, and/or the like. To utilize historical information, the system may access requests that have previously been received and performed, which may include requests that are currently running on the processing resources. The system may identify requests or jobs that have a similarity to the currently received job or request. Identifying a similar job or request may include utilizing a similarity identification technique or algorithm including, but not limited to, Euclidean distance similarity measure, cosine similarity measure, overlap similarity algorithm, Pearson similarity algorithm, Jaccard similarity algorithm, and/or the like. These similarity identification techniques and algorithms generally result in a similarity score or value that identifies how similar one request is to another request.

Using this score or value, the system can then filter requests or jobs that have a similarity within a predetermined threshold to another request or job. The predetermined threshold may vary based upon the request, job, client, and/or other factors. For example, clients having many previous requests or jobs may have a higher similarity threshold than clients having fewer previous requests or jobs. As another example, new requests or jobs that result in fewer results for similar requests or jobs may have a lower similarity threshold as compared to requests or jobs that have more results for similar requests or jobs. The system may also identify similarities to portions of the request or job. In other words, many requests or jobs can be broken into smaller parts or processes. The system can identify similar processes using a similarity identification technique. The identified similar processes can be aggregated to build an estimated resource usage for the entire job or request.

Using one or more artificial intelligence models, for example, as described in more detail previously, the system can compute a resource usage estimation. Using information and details about requests and jobs, historical or user provided actual or estimated resource usage, and any secondary information (e.g., industry standards for resource usage for particular jobs or requests, Internet sources, best practices, etc.), the artificial intelligence model(s) can be trained to identify correlations between information and details about requests and jobs and resource usage. Using this training, the artificial intelligence model(s) can make predictions regarding resource usage for a new request or job. As jobs are processed using the processing resources and resource usage is identified, the model(s) can use this information as feedback to learn new correlations or adjust the previously trained correlations. Thus, over time the model(s) become more refined and more accurate in identifying resource usage for new requests and jobs as they are received.

The system may also use a combination of techniques to identify a resource usage estimation. For example, the client may provide an estimated resource usage and the system can validate this estimation using historical information and/or one or more artificial intelligence models. As another example, the client may be able to provide an estimated resource usage for part of the request and the system can utilize historical information and/or one or more artificial intelligence models to estimate a resource usage for the remaining portion of the request.

Since the initial rate may be set based upon the estimated resource usage provided by the client, the system may determine how accurate historical resource usage estimations that have been provided by the client have been. The more accurate the resource usage estimations have been, the longer the monitoring period may be. Similarly, if the system utilizes historical information and/or one or more artificial intelligence models to estimate the resource usage, the system may assign a confidence score to those resource usage estimations. A higher confidence score indicates the system is more confident in the estimation, whereas a lower confidence score indicates the system is less confident in the estimation. Accordingly, a higher confidence score may result in a longer monitoring period, whereas a lower confidence score may result in a shorter monitoring period. Regardless, of how confident the system is regarding the estimation or how accurate the historical resource usage estimation is as provided by the client, the system may have a maximum length of time that the monitoring period can be. In other words, there is a point where an accuracy of estimation or a confidence value can no longer be utilized to extend the length of the monitoring period. The maximum length of the monitoring period may be a default length, set by a hosting entity, and/or the like.

When setting the initial rate, the system may identify a monetary amount that is desired by the entity over the subscription length or monitoring period. The desired amount includes the actual cost for the processing resource, any residual costs associated with the processing resource, any manpower costs, and profit for the hosting entity. Each processing resource type (e.g., GPU, CPU, memory, core, etc.) may have a different initial rate due to the differences in costs associated with each processing resource. Using the estimated resource usage, the system can calculate the cost for each measurement unit (e.g., time, number of units, etc.) of the resource usage. For example, the system may take the desired amount for the monitoring period for a particular resource and divide it by the estimated usage of that resource for the monitoring period. This quotient or numerical result would be equal to the rate that would need to be charged for a particular resource measurement unit to meet the desired amount. This is the number that may be used as the initial rate.

The hosting entity could adjust this rate up or down before it is set as the initial rate for the processing resource for the client. For example, negotiations may result in a lower number used for the initial rate. As another example, costs or profit desires may change and result in a higher or lower number used for the initial rate. As another example, the system may utilize an industry or hosting entity standard for resource usage cost which may result in a different number used for the initial rate. In the case that a standard rate is used for the initial rate, the system may not perform the above mentioned calculation. Alternatively, the system may perform the calculation and the compare that rate to the standard rate and then choose one of the calculated rate and/or standard rate, or another rate, to be set as the initial rate.

It should be noted that the initial rate may be the very first rate that is set with respect to the request or may be a subsequent rate that is being validated. In other words, the system will perform a few iterations of validating a rate for a period of time and adjusting the rate as needed. Accordingly, the initial rate may be the rate that is being validated, whereas the subsequent rate may be the rate that is set after the validation.

At 303, the utilization-based metering system determines if the initial rates meets a predetermined criteria for the monitoring period. In other words, the system validates the initial rate. The validation may occur after the expiration of the monitoring period or may occur shortly before expiration of the monitoring period, for example, a few weeks, a week, a few days, a few hours, and/or the like, before expiration of the monitoring period. The validation process identifies an amount of usage of the processing resource for the monitoring period and determines whether the initial rate meets a predetermined criteria in view of the amount of usage. In other words, the system identifies the usage of the processing resource and determines if the usage of the processing resource as charged using the initial rate meets the desired amount. To determine the resource usage measurement, the system performs monitoring of the resource usage using the monitoring component for the monitoring period. The monitoring component identifies the number of measurement units (e.g., length of time, number of units, etc.) that were used for each processing resource during the monitoring period.

As previously mentioned, the desired amount may be an amount identified for the entire subscription length. Accordingly, the predetermined criteria may be the desired amount as calculated for the monitoring period, whether that is an average of the desired amount for the monitoring period (i.e., desired amount divided by subscription length multiplied by the monitoring period length) or a more complicated computation of the amount needed for the monitoring period based upon estimated highs and lows in usage across the subscription length. Validating the initial rate may include multiplying the resource usage measurement unit by the initial rate, aggregating the product of the initial rates multiplied by the resource usage measurement units across all utilized resources, and comparing this aggregated value against the desired amount for the monitoring period (i.e., the monetary amount needed to be captured for the monitoring period based upon the overall desired amount for the subscription length).

After performing the validation, the system sets a subsequent rate for usage of the processing resource for a subsequent period of time. The subsequent period of time may be of the same length as the monitoring period or may be different. As previously mentioned, the steps of validating and setting subsequent rates is an iterative process. Accordingly, the subsequent period of time becomes the new monitoring period and the subsequent rate becomes the new initial rate for the next round of monitoring, validation, and setting of subsequent rates. This process occurs until the subscription length expires, the client stops using the processing resources, the hosting entity ends access to the processing resources by the client, and/or any other termination event.

If, responsive to performing the validation, the initial rate does meet the predetermined criteria, the system may set a subsequent rate that is the same or that matches the initial rate at 304. In other words, the system may maintain the initial rate as the subsequent rate for the subsequent period or the new monitoring period.

If, on the other hand, responsive to performing the validation, the initial rate does not meet the predetermined criteria (e.g., the aggregated value is not equal to the desired amount for the monitoring period), the system may set a subsequent rate that is different from the initial rate at 305 for the subsequent period or the new monitoring period. In the event the subsequent rate is different than the initial rate, the subsequent rate may be lower or higher than the initial rate. For example, the system may determine that the client used less processing resources than expected and may, therefore, adjust the subsequent rate to be higher than the initial rate. Even though the client is using less processing resources than expected, the client is only charged for the actual processing resources used. Thus, unlike a flat fee subscription formulation as in conventional systems, the client is only charged for the processing resources utilized. As another example, the system may determine that the client used more processing resources than expected and may, therefore, adjust the subsequent rate to be lower than the initial rate. In this case, even though the client used more processing resources than expected, the resource usage is charged at the initial rate. Thus, the hosting entity still gets paid for the entire usage of the processing resources.

The subsequent rate may also be different than the initial rate even if the estimated usage was equal to or close to the actual resource usage. One factor that may cause the change may be an expected difference in processing resource usage for the subsequent period or new monitoring period. For example, if the system identifies that the resource usage for the subsequent period will be different, either higher or lower, than the resource usage for the previous period (i.e., the monitoring period that was validated), the system may adjust the subsequent rate to be different than the initial rate (i.e., the rate that was set for the monitoring period that was validated) to account for the difference in resource usage across the periods.

The system may also take into account secondary factors which were identified in the previous period that increased or decreased expected costs. In other words, the subsequent rate may be set to account for the secondary factors. This identification of secondary factors and using them to set the subsequent rate may be performed using one or more artificial intelligence models. The one or more artificial intelligence models may identify the secondary factors, costs associated with the secondary factors, and then make a prediction regarding how the secondary factors will effect the cost of the hosting entity for the subsequent period and then set the subsequent rate based upon these new predicted costs.

Some secondary factors that may be taken into account may include factors that adjust the residual costs and/or the manpower costs. For example, a client who requests more technical support than was estimated causes an increase in manpower costs. This increased in manpower costs can be identified and taken into account when setting the subsequent rate. As another example, a client who runs jobs during peak power hours may require additional power and cooling as compared to job processing that is more evenly distributed over a day. This increase in residual costs can be identified and taken into account when setting the subsequent rate. Similarly, a decrease in the use of expected manpower or residual costs may result in a decrease in the subsequent rate.

As an overall non-limiting example of the described system, a client may provide a request to process a job that will use GPUs, CPUs, and memory over a 36 month subscription period. Based upon historical resource usage the system determines that the total server price for the subscription period will be $30,000.00 based upon an estimated usage of 16 cores, 5000 GB of memory, and 2 GPU cores, thereby making a monthly subscription rate of $833.33. Based upon an estimated utilization percent of 50%, the number of hours per month will be 360 hours, thereby resulting in a subscription price of $2.31 per hour of use if all resources are used as expected. In other words, the $2.31 per hour is the desired amount to meet the costs. The system sets the initial rates of the processing resources using this number in view of the expected resource usage, with each of the resources having a different initial rate based upon a percentage of the price attributable to each of the resources used, the residual costs, and the manpower costs. The initial rate for each of the processing resources is set based upon the subscription price per hour and the percentage attributable to each resource.

For this example, the monitoring period will be a length of two months. The system monitors the usage of the resources over the next two months. Upon expiration of, or close to the expiration of, the monitoring period, the system identifies the actual resource usage and then uses these values to validate the initial rate. If the client used the expected resources, the cost charged to the client for resources used for the monitoring period will result in a payment amount equal to or greater than the subscription price per hour. In other words, the cost charged to the client in this example will be at least equal to the $2.31 per hour across all the utilized resources. If the cost charged to the client is less than the $2.31 per hour across all the utilized resources, the system adjusts the subsequent rate to be result in a charge for the subsequent period to be closer to the $2.31 per hour across all the utilized resources.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
receiving, at a utilization-based metering system, a request from a user to use a processing resource of an entity offered as-a-service by the entity;
setting, using the utilization-based metering system, an initial rate for usage of the processing resource over a period of time;
validating, using the utilization-based metering system and in view of the period of time, the initial rate, wherein the validating comprises identifying an amount of usage of the processing resource for the period of time and determining whether the initial rate meets a predetermined criteria in view of the amount of usage; and
setting, using the utilization-based metering system and based upon the validating, a subsequent rate for usage of the processing resource for a subsequent period of time.

2. The method of claim 1, wherein the setting an initial rate comprises receiving, from the user, an identification of an estimated amount of usage of the processing resource over the period of time.

3. The method of claim 1, wherein the setting an initial rate comprises utilizing historical information regarding resource usage by the user.

4. The method of claim 1, wherein the setting an initial rate comprises performing an analysis of resource usage by the user.

5. The method of claim 1, wherein the setting a subsequent rate comprises identifying secondary factors with respect to the user and wherein the subsequent rate accounts for the secondary factors.

6. The method of claim 5, wherein the setting the subsequent rate in view of the secondary factors is performed utilizing an artificial intelligence model.

7. The method of claim 1, wherein the setting a subsequent rate comprises adjusting, responsive to the validating indicating the initial rate does not meet the predetermined criteria, the initial rate to the subsequent rate, wherein the subsequent rate is different than the initial rate.

8. The method of claim 1, wherein the setting a subsequent rate comprises maintaining, responsive to the validating indicating the initial rate does meet the predetermined criteria, the initial rate as the subsequent rate, wherein the subsequent rate is the same as the initial rate.

9. The method of claim 1, wherein the request to use a processing resource comprises an overall length of time of usage and wherein the predetermined criteria is identified based upon the overall length of time of usage.

10. The method of claim 1, wherein different processing resources have different initial rates.

11. A system, the system comprising:
a processor;
a memory device that stores instructions that, when executed by the processor, causes the system to:
receive, at a utilization-based metering system, a request from a user to use a processing resource of an entity offered as-a-service by the entity;
set, using the utilization-based metering system, an initial rate for usage of the processing resource over a period of time;
validate, using the utilization-based metering system and in view of the period of time, the initial rate, wherein the validating comprises identifying an amount of usage of the processing resource for the period of time and determining whether the initial rate meets a predetermined criteria in view of the amount of usage; and
set, using the utilization-based metering system and based upon the validating, a subsequent rate for usage of the processing resource for a subsequent period of time.

12. The system of claim 11, wherein the setting an initial rate comprises receiving, from the user, an identification of an estimated amount of usage of the processing resource over the period of time.

13. The system of claim 11, wherein the setting an initial rate comprises utilizing historical information regarding resource usage by the user.

14. The system of claim 11, wherein the setting an initial rate comprises performing an analysis of resource usage by the user.

15. The system of claim 11, wherein the setting a subsequent rate comprises identifying secondary factors with respect to the user and wherein the subsequent rate accounts for the secondary factors.

16. The system of claim 15, wherein the setting the subsequent rate in view of the secondary factors is performed utilizing an artificial intelligence model.

17. The system of claim 11, wherein the setting a subsequent rate comprises adjusting, responsive to the validating indicating the initial rate does not meet the predetermined criteria, the initial rate to the subsequent rate, wherein the subsequent rate is different than the initial rate.

18. The system of claim 11, wherein the setting a subsequent rate comprises maintaining, responsive to the validating indicating the initial rate does meet the predetermined criteria, the initial rate as the subsequent rate, wherein the subsequent rate is the same as the initial rate.

19. The system of claim 11, wherein the request to use a processing resource comprises an overall length of time of usage and wherein the predetermined criteria is identified based upon the overall length of time of usage.

20. A product, the product comprising:
a computer-readable storage device that stores executable code that, when executed by a processor, causes the product to:
receive, at a utilization-based metering system, a request from a user to use a processing resource of an entity offered as-a-service by the entity;
set, using the utilization-based metering system, an initial rate for usage of the processing resource over a period of time;
validate, using the utilization-based metering system and in view of the period of time, the initial rate, wherein the validating comprises identifying an amount of usage of the processing resource for the period of time and determining whether the initial rate meets a predetermined criteria in view of the amount of usage; and
set, using the utilization-based metering system and based upon the validating, a subsequent rate for usage of the processing resource for a subsequent period of time.
